(19) United States
(12) Patent Application Publication
(10) Pub. No.: US 2014/0082517 A1
(43) Pub. Date: Mar. 20, 2014

(54) FACILITATING DYNAMIC CREATION, CUSTOMIZATION, AND EXECUTION OF KEYBOARD SHORTCUTS IN AN ON-DEMAND SERVICES ENVIRONMENT

(71) Applicants: GAUTAM VASUDEV, San Francisco, CA (US); Michael Wang, San Francisco, CA (US); David Ly-Gagnon, San Francisco, CA (US); Reddy Yerradoddi, Fremont, CA (US); Brett Schuenemann, Chicago, IL (US); Peng-Wen Chen, Foster City, CA (US)

(72) Inventors: GAUTAM VASUDEV, San Francisco, CA (US); Michael Wang, San Francisco, CA (US); David Ly-Gagnon, San Francisco, CA (US); Reddy Yerradoddi, Fremont, CA (US); Brett Schuenemann, Chicago, IL (US); Peng-Wen Chen, Foster City, CA (US)

(73) Assignee: salesforce.com, inc., San Francisco, CA (US)

(21) Appl. No.: 14/015,485

(22) Filed: Aug. 30, 2013

Related U.S. Application Data
(60) Provisional application No. 61/701,488, filed on Sep. 14, 2012.

(51) Int. Cl. G06F 3/0489

(52) U.S. Cl. CPC G06F 3/0489
USPC 715/747

(57) ABSTRACT

In accordance with embodiments, there are provided mechanisms and methods for facilitating dynamic creation, customization, and execution of keyboard shortcuts in an on-demand services environment in a multi-tenant environment according to one embodiment. In one embodiment and by way of example, a method includes receiving, at a computing device, a request from a user to invoke a keyboard shortcut across a plurality of web domains at the computing device, where the plurality of web domains may comprise a primary web domain and one or more secondary web domains. The method may further include facilitating interaction between the primary web domain and the one or more secondary web domains, where facilitating interaction includes negotiating invocation of the shortcut within the one or more secondary web domains, and invoking the shortcut across the plurality of web domains.

### CLAIM OF PRIORITY

This application claims the benefit of and priority to U.S. Provisional Patent Application No. 61/701,488, entitled “Method and System for Using Keyboard Shortcuts Across Domains in an On-Demand System” by Gautam Vasudev, filed Sep. 14, 2012, Attorney Docket No.: 8956P142Z, and the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

One or more implementations relate generally to data management and, more specifically, to a mechanism for facilitating dynamic creation, customization, and execution of keyboard shortcuts in an on-demand services environment.

### BACKGROUND

With increasing workloads on multiple domains, users find it difficult to perform tasks without having keyboard shortcuts to help perform such tasks. Further, conventional shortcut techniques are limited to a single domain and thus lack consistency over multiple domains, making their use cumbersome, time-consuming, and error-prone.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches.

In conventional database systems, users access their data resources in one logical database. A user of such a conventional system typically retrieves data from and stores data on the system using the user's own systems. A user system might remotely access one of a plurality of server systems that might in turn access the database system. Data retrieval from the system might include the issuance of a query from the user system to the database system. The database system might process the request for information received in the query and send to the user system information relevant to the request. The secure and efficient retrieval of accurate information and subsequent delivery of this information to the user system has been and continues to be a goal of administrators of database systems. Unfortunately, conventional database approaches are associated with various limitations.

### BRIEF DESCRIPTION OF THE DRAWINGS

In the following drawings like reference numbers are used to refer to like elements. Although the following figures depict various examples, one or more implementations are not limited to the examples depicted in the figures.

FIG. 1 illustrates a computing device employing a dynamic keyboard shortcuts creation and customization mechanism according to one embodiment;

FIG. 2 illustrates a dynamic keyboard shortcuts creation and customization mechanism and a dynamic shortcuts execution framework according to one embodiment;

FIG. 3A illustrates a method for dynamic creation and customization of keyboard shortcuts in an on-demand services environment in a multi-tenant environment according to one embodiment;

FIG. 3B illustrates a method for dynamic execution of keyboard shortcuts in an on-demand services environment in a multi-tenant environment according to one embodiment;

FIG. 4A-4I illustrate screenshots of layouts as facilitated by dynamic keyboard shortcuts mechanism of FIG. 1 according to one embodiment;

FIG. 5 illustrates a computer system according to one embodiment;

FIG. 6 illustrates an environment wherein an on-demand database service might be used according to one embodiment; and

FIG. 7 illustrates elements of environment of FIG. 6 and various possible interconnections between these elements according to one embodiment.

### SUMMARY

In accordance with embodiments, there are provided mechanisms and methods for facilitating dynamic creation, customization, and execution of keyboard shortcuts in an on-demand services environment in a multi-tenant environment according to one embodiment. In one embodiment and by way of example, a method includes receiving, at a computing device, a request from a user to invoke a keyboard shortcut across a plurality of web domains at the computing device, where the plurality of web domains may comprise a primary web domain and one or more secondary web domains. The method may further include facilitating interaction between the primary web domain and the one or more secondary web domains, where facilitating interaction includes negotiating invocation of the shortcut within the one or more secondary web domains, and invoking the shortcut across the plurality of web domains.

While the present invention is described with reference to an embodiment in which techniques for facilitating management of data in an on-demand services environment are implemented in a system having an application server providing a front end for an on-demand database service capable of supporting multiple tenants, the present invention is not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

### DETAILED DESCRIPTION

Methods and systems are provided for facilitating dynamic creation, customization, and execution of keyboard shortcuts in an on-demand services environment in a multi-tenant environment according to one embodiment. In one embodiment and by way of example, a method includes receiving, at a computing device, a request from a user to invoke a keyboard shortcut across a plurality of web domains at the computing device, where the plurality of web domains may comprise a primary web domain and one or more secondary web domains. The method may further include facilitating interaction between the primary web domain and the one or more secondary web domains, where facilitating interaction includes negotiating invocation of the shortcut within the one or more secondary web domains, and invoking the shortcut across the plurality of web domains.

Embodiment provide for dynamic and efficient creation and customization of keyboard shortcuts (also referred to as “hotkeys”) in an on-demand services environment in a multi-tenant environment according to one embodiment. Embodiments further provide for user-based customization of shortcuts such as each shortcut may be used over multiple domains (e.g., web domains, such as websites) to perform various tasks across multiple domains, where any two or more domains (e.g., Force.com®, Facebook®, Gmail®, etc.) being may be entirely independent of each other. It is to be noted that terms like “domain”, “web domain”, and “website” may be used interchangeably throughout this document. In one embodiment, shortcuts allow users to perform their tasks using a keyboard, virtually eliminating the use of the mouse while enhancing efficiency by significantly reducing the number of clicks that are typically required to perform a task. Embodiments provide for a set of default hotkeys for performing relatively basic tasks along with a setup to allow the user to create custom hotkeys that may be created and customized by the user to perform any number and type of tasks. It is contemplated that shortcuts may be used for performing manipulation of data, such as navigation, editing, saving, etc., of data. Further, by having associated multiple tasks or actions with a single customized shortcut may significantly reduce the time typically needed to perform such manipulation actions, such as a single shortcut may be used for saving a file followed by closing of the file followed by opening of a new file.

As used herein, a term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Embodiments are described with reference to an embodiment in which techniques for facilitating management of data in an on-demand services environment are implemented in a system having an application server providing a front end for an on-demand database service capable of supporting multiple tenants, embodiments are not limited to multi-tenant databases nor deployment on application servers. Embodiments may be practiced using other database architectures, i.e., ORACLE®, DB2® by IBM and the like without departing from the scope of the embodiments claimed.

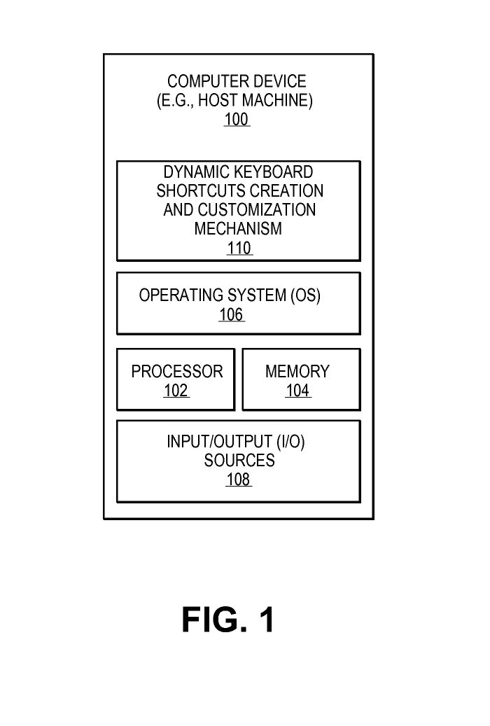

FIG. 1 illustrates a computing device 100 employing a dynamic keyboard shortcuts creation and customization mechanism 110 according to one embodiment. In one embodiment, computing device 100 serves as a host machine for employing dynamic keyboard shortcuts creation and customization mechanism (“creation and customization mechanism”) 110 for facilitating dynamic creation and application of keyboard shortcuts or hotkeys over multiple channels or domains in a multi-tiered, multi-tenant, on-demand services environment. The term “user” may refer to a system user, such as, but not limited to, a software/application developer, a system administrator, a database administrator, an information technology professional, a program manager, product manager, etc. The term “user” may also refer to an end-user, such as, but not limited to, an organization (e.g., a business, a company, a corporation, a non-profit entity, an institution, an agency, etc.) serving as a customer or client of the provider (e.g., Salesforce.com®) of creation and customization mechanism 110 or the organization's representative, such as a salesperson, a sales manager, a product manager, an accountant, a director, an owner, a president, a computer programmer, an information technology (IT) representative, etc.

It is to be noted that any references to data/metadata (e.g., Customer Relationship Model (CRM) data/metadata, etc.), computing devices (e.g., server computers, desktop computers, mobile computers, such as tablet computers, smartphones, etc.), software development languages, applications, and/or development tools or kits (e.g., Force.com®, Force.com Apex™ code, JavaScript™, jQuery™, Developerforce™, Visualforce™, Service Cloud Console Integration Toolkit™ (“Integration Toolkit” or “Toolkit”), Platform on a Service™ (PaaS), Chatter® Groups, Sprint Planner®, MS Project®, etc.), etc., discussed in this document are merely used as examples for brevity, clarity, and ease of understanding and that embodiments are not limited to any one type of data/metadata, computing devices, techniques, programming languages, software applications, software development tools/kits, etc.

Computing device 100 may include server computers (e.g., cloud server computers, etc.), desktop computers, cluster-based computers, set-top boxes (e.g., Internet-based cable television set-top boxes, etc.), and the like. Computing device 100 may also include smaller computers, such as mobile computing devices, such as cellular phones including smartphones (e.g., iPhone® by Apple®, BlackBerry® by Research in Motion® Limited, now known and trading as BlackBerry®, etc.), handheld computing devices, personal digital assistants (PDAs), etc., tablet computers (e.g., iPad® by Apple®, Galaxy® by Samsung®, etc.), laptop computers (e.g., notebooks, netbooks, Ultrabook™, etc.), e-readers (e.g., Kindle® by Amazon.com®, Nook® by Barnes and Nobles®, etc.), Global Positioning System (GPS)-based navigation systems, cable setup boxes, etc.

Computing device 100 includes an operating system (OS) 106 serving as an interface between any hardware or physical resources of the computing device 100 and a user. Computing device 100 further includes one or more processors 102, memory devices 104, network devices, drivers, or the like, as well as input/output (I/O) sources 108, such as touchscreens, touch panels, touch pads, virtual or regular keyboards, virtual or regular mice, etc. It is to be noted that terms like “node”, “computing node”, “server”, “server device”, “cloud computer”, “cloud server”, “cloud server computer”, “machine”, “host machine”, “device”, “computing device”, “computer”, “computing system”, “multi-tenant on-demand data system”, and the like, may be used interchangeably throughout this document. It is to be further noted that terms like “application”, “software application”, “program”, “software program”, “package”, and “software package” may be used interchangeably throughout this document. Moreover, terms like “job”, “input”, “request” and “message” may be used interchangeably throughout this document. Similarly, terms like “keyboard shortcut”, “shortcut”, and “hotkey” may be used interchangeably throughout this document.

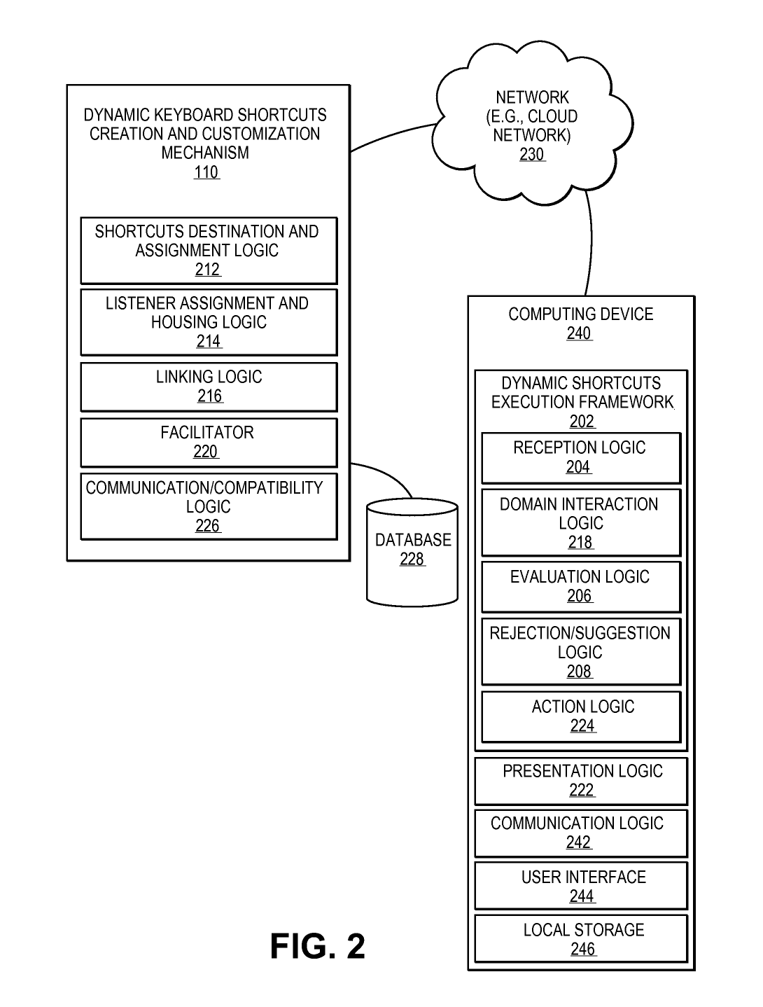

FIG. 2 illustrates a dynamic keyboard shortcuts creation and customization mechanism 110 and a dynamic shortcuts execution framework 202 according to one embodiment. In one embodiment, creation and customization mechanism 110 may include a number of components, such as shortcut definition and assignment logic 212, listener assignment and housing logic 214, linking logic 216, and facilitator 220. In one embodiment, creation and customization mechanism 110 may be employed by a host machine, such as computing device 100 of FIG. 1, in communication with one or more databases, such as database 228, one or more computing devices, such as computing device 240 serving as a client computing device, over one or more networks, such as network 230. In one embodiment, computing device 240 may include: dynamic shortcuts execution framework (“execution framework”) 202 having reception logic 204, domain interaction logic 218, evaluation logic 206, rejection/suggestion logic 208, and action logic 224; presentation logic 222, communication logic 242, and user interface 244. Computing device 240 may further include a local storage 246 and may be in communication with one or more local databases or remote databases, such as database 228 over network 230.

Throughout this document, “logic”, “component”, “module”, “framework”, and “engine” may be referenced interchangeably and include, by way of example, software, hardware, and/or any combination of software and hardware, such as firmware. Further, any use of a particular brand, word, or term, such as “keyboard shortcuts”, “shortcuts”, “hotkeys”, “Visualforce”, “Integration Toolkit”, “Apex”, “CRM”, etc., should not be read to limit embodiments to software or devices that carry that label in products or in literature external to this document.

In one embodiment, two forms of shortcuts may be provided: standard and custom. Standard shortcuts may be predefined and displayed for the user at computing device 240 as facilitated by presentation logic 222. In some embodiments, these standard shortcuts may include navigation shortcuts, editing shortcuts, and other similar shortcuts, etc., and can be requested to be changed or disabled, as desired or necessitated by the user, via execution framework 202. For example, to use a standard shortcut, the keyboard shortcut mode may be entered by simply pressing a key, such as the “esc” key. If the keyboard shortcut mode is already being displayed at computing device 240, the user may start using the standard shortcuts without have to hit any other key or entering the shortcut mode.

Some examples of the standard shortcuts may include: 1) navigation hotkeys to allow the user to navigate through the console (e.g., press “n” to open the navigation panel, etc.); 2) editing hotkeys to allow the user to edit accounts, records, etc. (e.g., press “enter” to open display account details, “e” to edit the account, etc.); 3) hotkeys help list to help the user with a list of hotkeys for their console (e.g., type “ctrl+h” to open the help list or panel, etc.); 4) hotlinks to help link or group two or more hotkeys together into a single hotkey to be able to perform multiple tasks using a single hotkey; 5) blowout hotkeys for zooming-in and zooming-out of various panels and certain components of the panels, such as navigation tabs, primary tabs, sidebar components, etc.

In some embodiments, a user may place a request for creation of a keyboard shortcut via user interface 244 at computing device 240. The request may be then communicated on to creation and customization mechanism 110 by communication logic 242 over network 230. For example, the user may request to create a shortcut to perform a single task, such as ctrl+L for logout of the account, or choose to combine multiple tasks into a single shortcut, such as combine the shortcuts for save the file (e.g., ctrl+S) and logout of the account (e.g., ctrl+L) into a single shortcut for save and logout, such as shift+X. The shortcut request may be processed at shortcuts definition and assignment logic 212 to assign the requested shortcut (e.g., shift+X) to the relevant task (e.g., save and logout) or vice versa and associate any description provided by the user to the requested shortcut. Regarding the description, for example, when requesting the shortcut, the user may choose to fill out q space provided for shortcut details by providing a short description (e.g., “save the file and logout”) of the requested shortcut. This may be regarded as a good practice to help remember the task relating to the new shortcut and avoid any potential conflicts with any of the existing tasks or events in the console. In one embodiment, shortcuts may be stored at database 228 as well as at a local database or storage 246 associated with computing device 240.

It is contemplated that creation and customization mechanism 110 and execution framework 202 may be powered by any number and type of development and processing tools, such as Visualforce, Integration Toolkit, Apex code, etc. Further, for example and as will be further described below, when creating a custom shortcut, the user may launch a global console event to which a console listener reacts and may use an event receiver defined with the Integration Toolkit. In other words, custom keyboard shortcuts may invoke any number and type of Toolkit methods, which means custom shortcuts can launch a host of user interface and data operations and perform any number and type of actions supported by the Toolkit as well as the Apex and Visualforce callouts. In some embodiments, the user of computing device 240 may choose to request a custom shortcut or hotkey in an on-demand system, such as Salesforce.com, to be used to perform one or more tasks in multiple domains, such as to perform customer service tasks (e.g., accounting, billing, inventory, sales, etc.) within the service cloud console of Salesforce.com and one or more social network environments (e.g., Facebook®), one or more emails systems (e.g., Gmail®), etc. For example, one or more newly-created hotkeys may be aligned with the user's workflow to facilitate any number of corresponding tasks over multiple domains.

Further, the user may wish the shortcut to be available all the time and thus a “listener” may be generated and made available at all times in the console. Since footer components of the console are always made available on the console page, they may be regarded as a good place for housing the listener. The user may choose to keep the listener hidden if they do not wish to display all the information each time the shortcut is invoked. For example, to build the corresponding listener component, the user may build the listener using a Visualforce page (e.g., Custom Console Component Shortcuts Listener (cccShortcutsListener) page) containing the listener logic along with the keyboard shortcuts code offered by, for example, Developerforce.com. Subsequently, the listener may be requested by the user to be named (e.g., ShortcutsListener) and housed and hidden. In one embodiment, the listener component may be created, housed, and then hidden by listener assignment and housing logic 214.

Furthermore, in some embodiments, listener assignment and housing logic 214 may house reception logic 204 which is triggered and launched, as facilitated by facilitator 220, each time a shortcut invocation request is placed by the user at computing device 240. For example, reception logic 204 may correspond to every shortcut and each time a shortcut (e.g., shift+M) is typed in by the user, via user interface 244, facilitator 220 facilitates reception logic 204 to receive the user's shortcut invocation request and initiate its processing.

In some embodiments, when creating a new shortcut to perform multiple tasks without existing shortcuts, linking logic 216 may be used to link two or more tasks, such as “close, email and logout”, to be performed by a single shortcut, such as alt+X to close the file, email the file, and then logout, as requested by the user. In other embodiments, when merging two or more existing shortcuts into a single shortcut, linking logic 216 may link the existing shortcuts (e.g., ctrl+S for save and ctrl+L logout) into a single custom shortcut, such as shift+M to save and logout. It is contemplated that various letters, characters, and terms like “shift”, “alt”, “ctrl”, “+”, “ ”L”, “X”, etc., are merely used here as examples and for the sake of brevity and clarity and that embodiments are not limited to any particular letters, characters, terms, formats, etc., and any combination thereof.

It is contemplated that anytime subsequent to creation of a shortcut, the shortcut may be invoked by the user. Embodiments are not limited to any particular time period, such as hours or days or even months after which a shortcut may be invoked. Upon invoking a shortcut, such as upon typing in the shortcut via user interface 244, a user shortcut invocation request is generated and received at reception logic 204. As aforementioned, in some embodiments, each shortcut may have a corresponding reception logic 204 which may be housed at listener assignment and housing logic 214 and triggered or facilitated, via facilitator 220, in response to the launching of a global console event name in response to the invoking of the shortcut. It is contemplated that in case of a shortcut that does not exist, such as never been created or previously deleted, etc., the invocation request may not go

Once the invocation request is received at reception logic 204, domain interaction logic 218 is triggered to facilitate the potential use of the shortcut over multiple domains if the user is using two or more domains. In one embodiment, if the user has two or more domains open (Force.com console serving as a primary domain and Microsoft® Bing™ or Bing.com™ serving as a secondary domain), domain interaction logic 218 may negotiate the use of the user-invoked shortcut with any number and type of secondary domains, such as Bing. It is contemplated that each domain may use different parameters and protocols and thus domain interaction logic 218 may negotiate with each domain according to its own parameters and protocols. For example, certain tasks may not be accommodated or allowed by certain domains, such as Microsoft Bing being a search engine may not allow emailing which may then facilitate domain interaction logic 218 to negotiate the email part of the shortcut with an email domain (e.g., Outlook® (Outlook.com) by Microsoft Corp., Gmail® (Gmail.com) by Google Corp., etc.) preferred or being used by the user. In some embodiments, the user may occasionally change secondary domains (such as close Bing and open LinkedIn®) and in response, domain interaction logic 218 may dynamically negotiate the use of any number and type of shortcuts with various domains so that the shortcuts may continue to be used seamlessly over multiple domains. In some embodiment, domains include web domains (e.g., websites).

It is contemplated that a secondary domain may be an organization's own domain (e.g., a cable company's internally created sales application/data/reports, etc.), sub-contractor's domain (e.g., a restaurant contracting an independent software company to create sales application/data/reports, etc.), an entirely independent and/or incompatible domain (e.g., a bank using an independent application, such as Gmail, Bing.com, NYTimes.com® by New York Times®, Wikipedia.org™ by Wikimedia™ Foundation, Zillow.com™ by Zillow®, etc.), or the like. Using domain interaction logic 218, a user at an organization (e.g., a sales representative at a cable company) may seamlessly navigate between, for example, cable customer/potential customer data provided in the primary domain, such as the Salesforce console, and promotional deals available for cable customers/potential customers provided in a secondary domain (e.g., internally created or sub-contracted report) without having to use different shortcuts for different domains. For example, the user may use any number and type of standard and/or custom shortcuts (such as move up, move down, open account, search, logout, etc.) in multiple domains, such as while reviewing real estate sales or contact data in one domain (e.g., Force.com, Data.com®) serving as a primary domain and checking email (e.g., Gmail.com) and/or searching the Internet (e.g., Realtor.com® by National Association of Realtors®, Zillow.com, etc.) in other domains serving as secondary domains.

The user shortcut invocation request may then be evaluated by evaluation logic 206 for its potential for completion. For example, the shortcut invoked by the user calls for saving of a file, but if the file is read-only (such as at least in one domain), the invoked shortcut may not be allowed to be completed either entirely or in one or more domains (as further determined from domain interaction logic 218). In this case, evaluation logic 206 may forward the invocation request to rejection/suggestion logic 208. In one embodiment, rejection/suggestion logic 208 may reject the invocation request and throw an error, issue a notification for partial rejection, offer suggestions on altering the shortcut or use a different shortcut for better results, or the like.

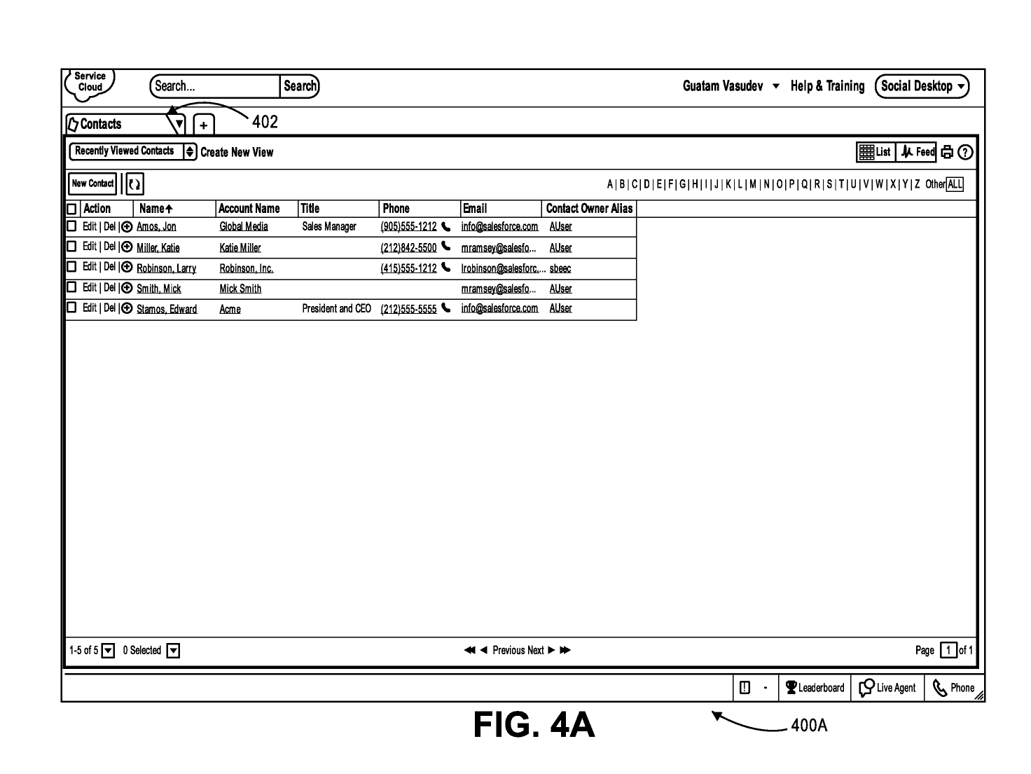

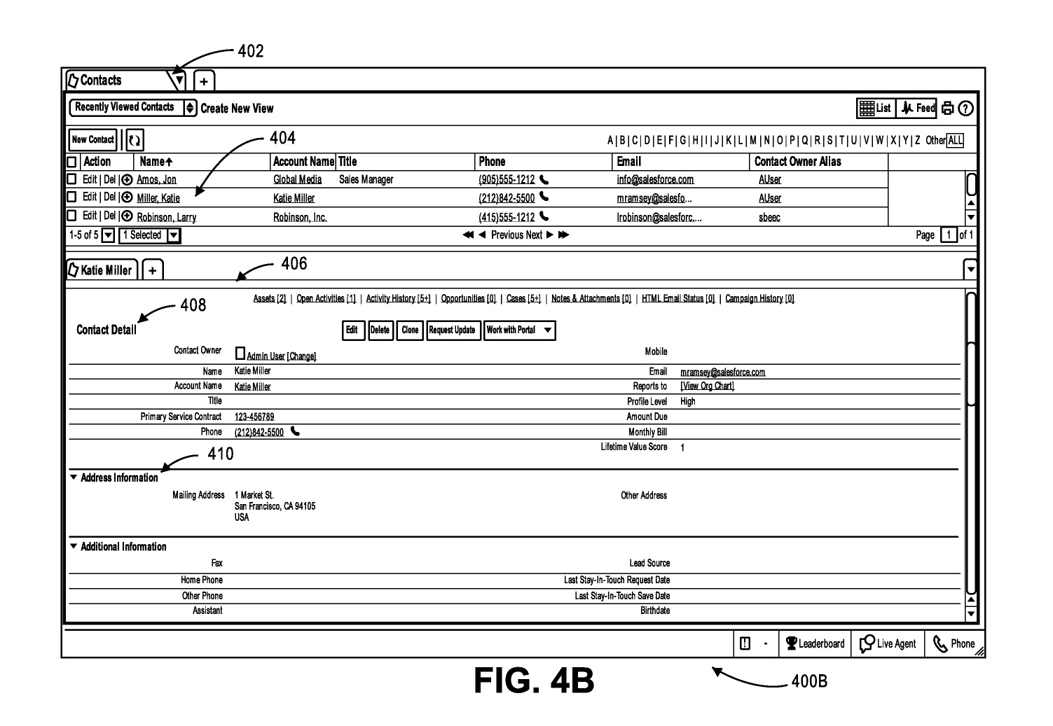

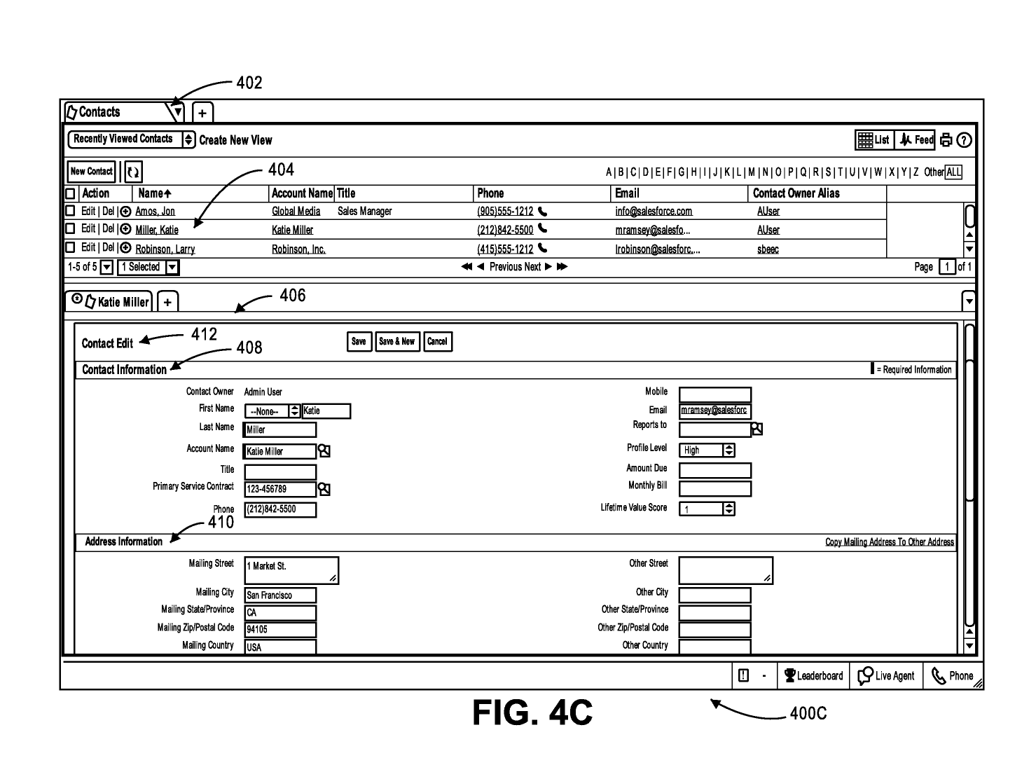

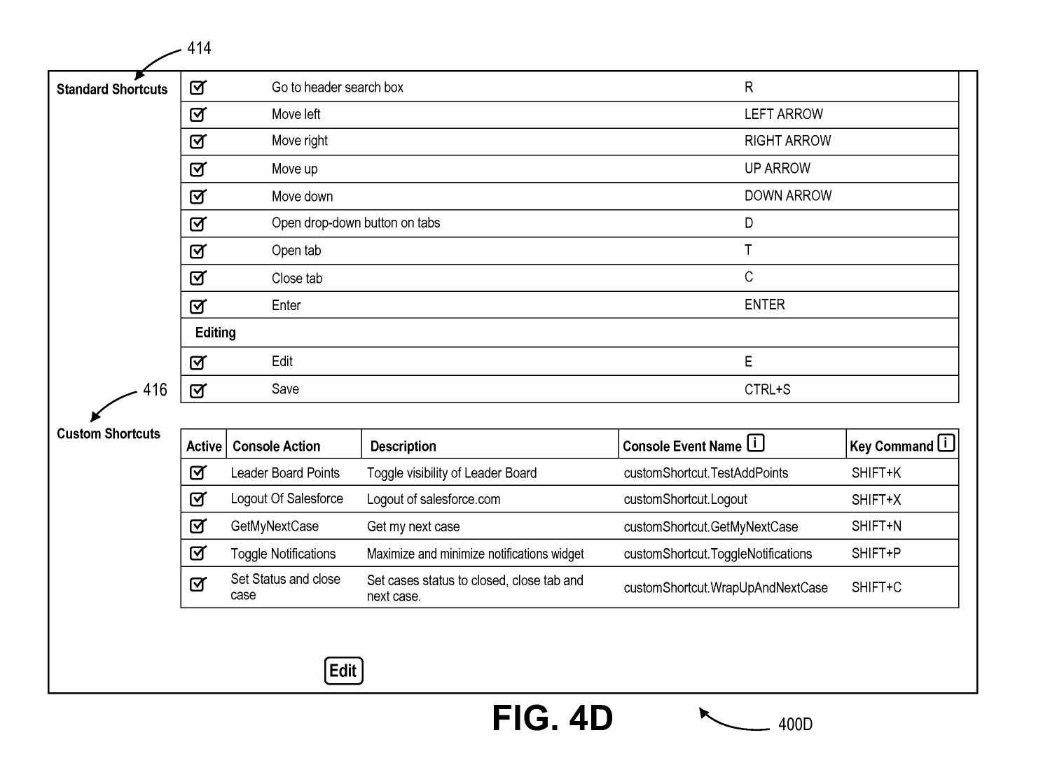

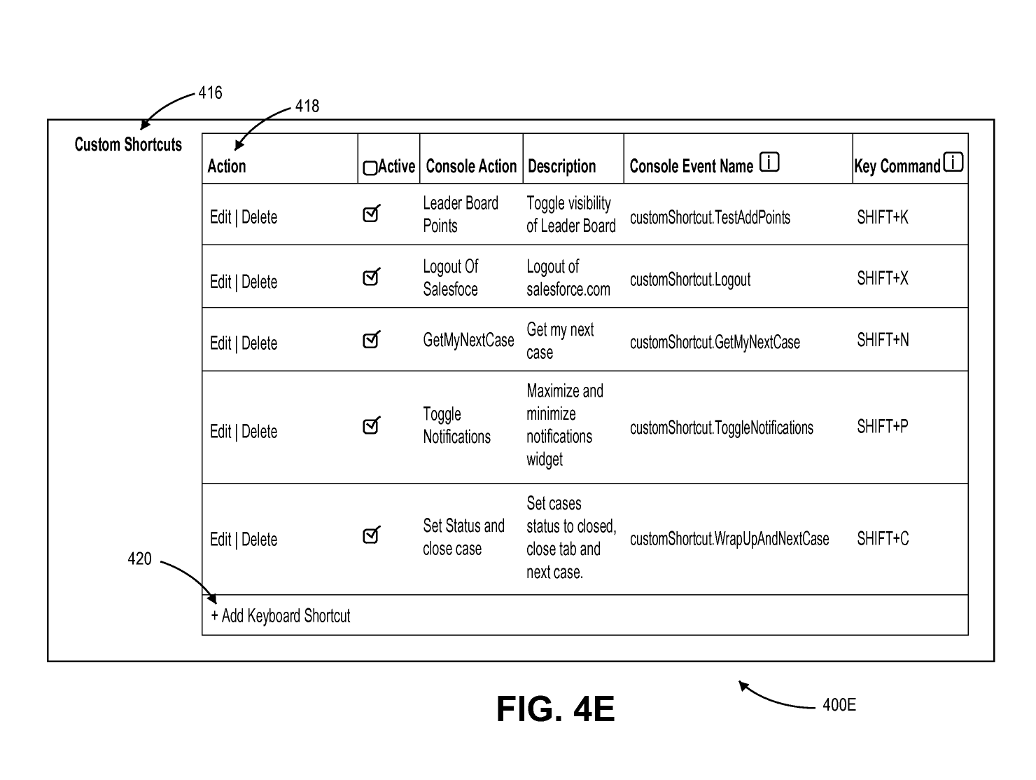

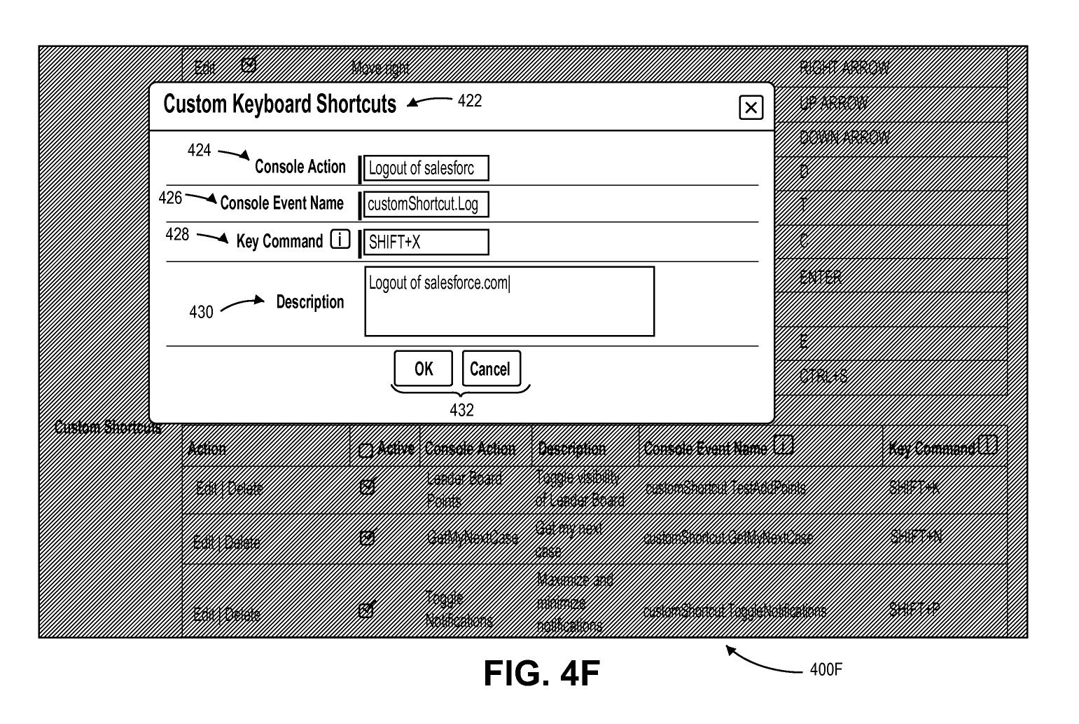

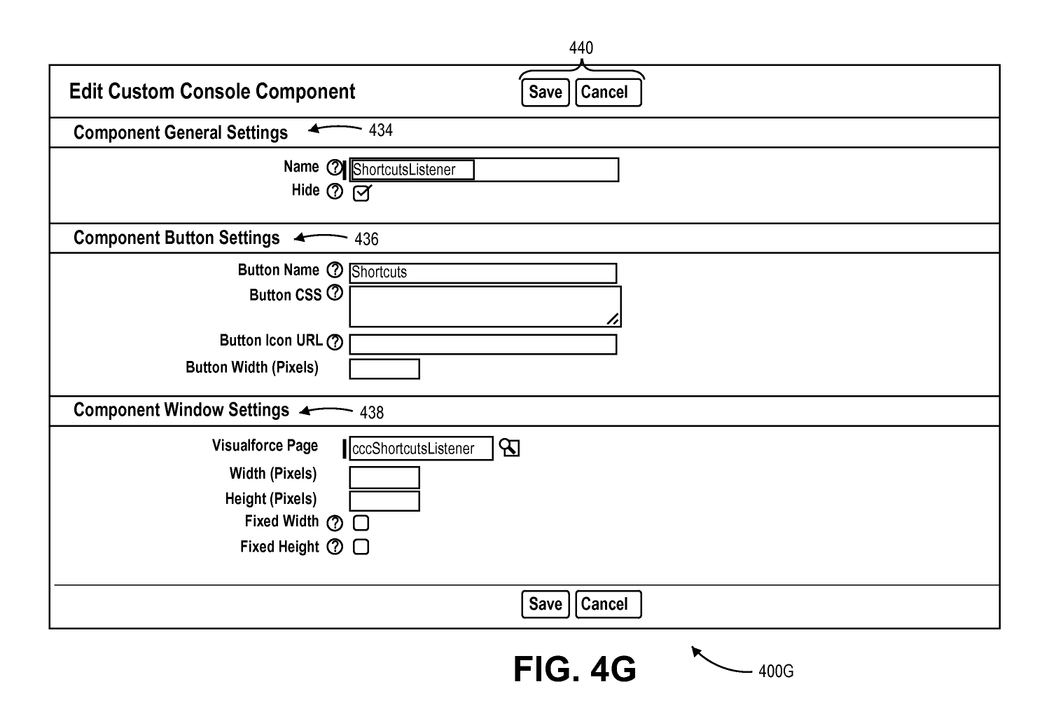

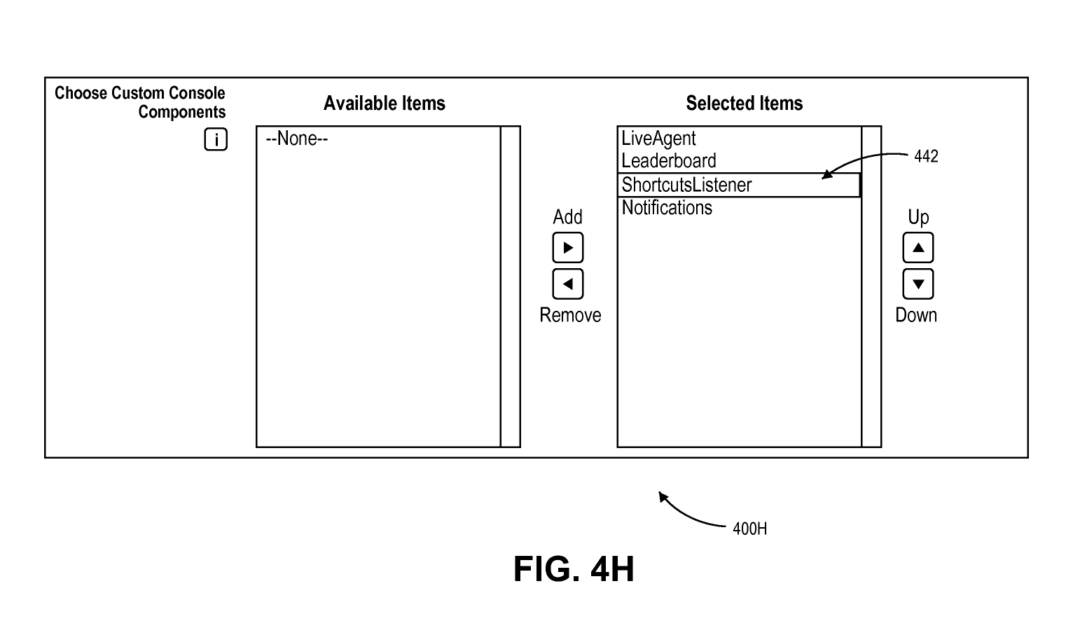

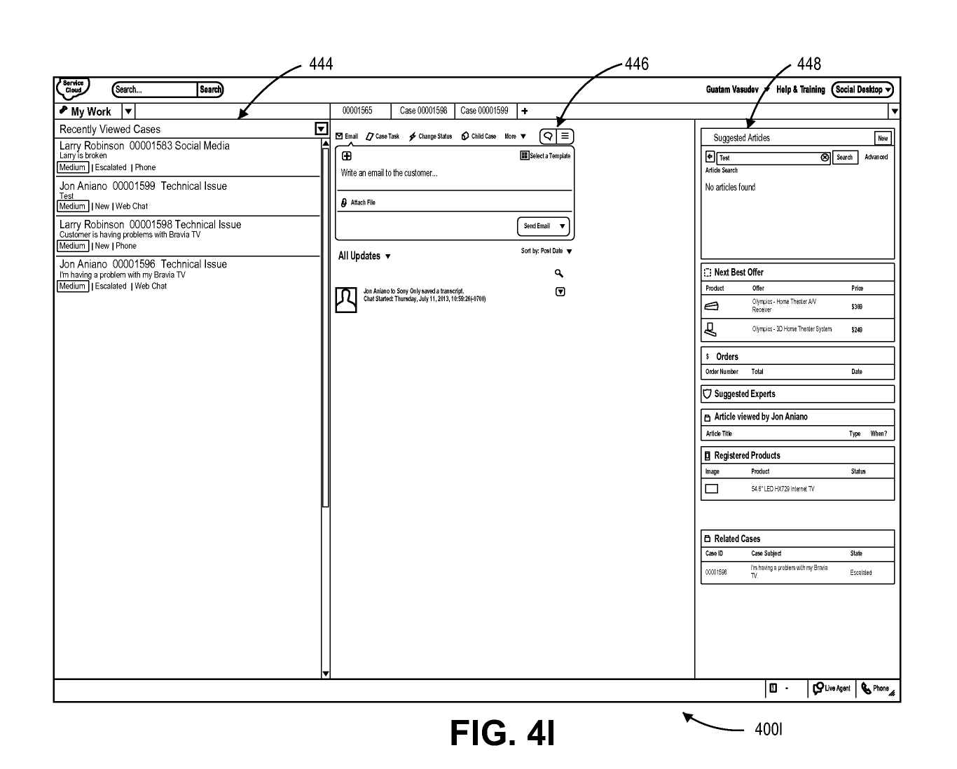

Upon completely or partially accepting the invocation request, action logic 224 may authenticate and execute the invoked shortcut. For example, action logic 224 facilitates that pressing “n” opens the navigation page, hitting “e” opens the edit page, typing in shift+M triggers saves the file and logs out of the account, etc. Action logic 224 may not only facilitate the intended actions of the shortcuts, but also any other relevant actions. In one embodiment, presentation logic 222 facilitates, over network 230, the presentation or displaying of shortcuts and other relevant information at computing device 240. For example, shortcut results may be displayed (such as displaying “file saved” when a file is saved using a shortcut, etc.), via user interface 244 (e.g., Graphical User Interface (GUI) as illustrated with reference to FIGS. 4A-4I), using a display device in communication with computing device 240.

With regard to each of the multiple domains receiving the invoked shortcut, in one embodiment, as with having reception logic 204 correspond to each shortcut (such as ctrl+S, shift+M, etc.), reception logic 204 may also correspond to each domain (e.g., Bing.com, internal billing system, etc.) and as such listener assignment and housing logic 214 may be generated to be associated with each domain. For example, upon creating listener assignment and housing logic 214, reception logic 204 may be associated with it and the process may be repeated for each domain across multiple domains, such as Bing.com may respond to a shortcut if the corresponding listener assignment and housing logic 214 has a receiver listener associated with the shortcut. Further, keyboard shortcuts may be communicated to various listeners via local storage 246 and the associated global event model.

Communication/compatibility logic 226 may facilitate the ability to dynamically communicate and stay configured with any number and type of software/application developing tools, models, data processing servers, database platforms and architectures, programming languages and their corresponding platforms, etc. Communication/compatibility logic 226 further facilitates the ability to dynamically communicate and stay configured with various computing devices (e.g., server computing device, mobile computing devices, such as smartphones, tablet computers, laptop, etc.), networks (e.g., cloud network, intranet, the Internet, proximity network, such as Bluetooth, WiFi, etc.), websites (e.g., social networking websites, such as Facebook®, LinkedIn®, Google+®, Twitter®, etc.), and the like, while ensuring compatibility with changing technologies, parameters, protocols, standards, etc.

It is contemplated that any number and type of components may be added to and/or removed from dynamic shortcuts creation and customization mechanism 110 and dynamic shortcuts execution framework 202 to facilitate various embodiments including adding, removing, and/or enhancing certain features. For brevity, clarity, ease of understanding, many of the standard and/or known components, such as those of a computing device, are not shown or discussed here. It is contemplated that embodiments are not limited to any particular technology, topology, system, architecture, and/or standard and are dynamic enough to adopt and adapt to any future changes.

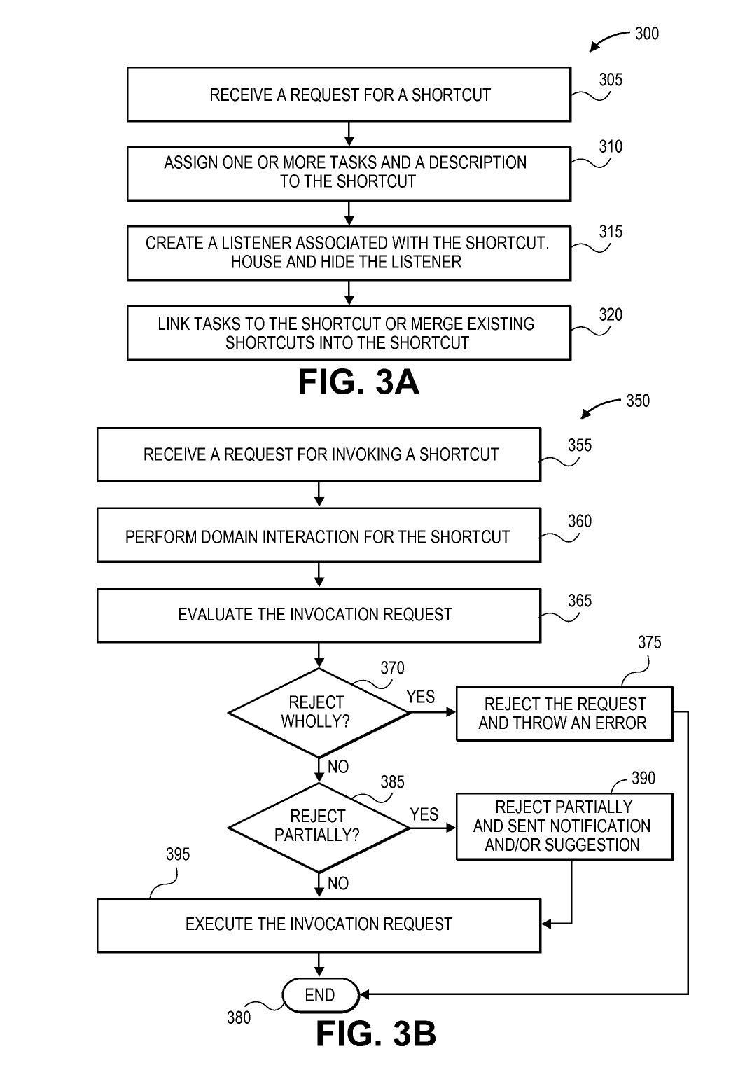

FIG. 3A illustrates a method for dynamic creation and customization of keyboard shortcuts in an on-demand services environment in a multi-tenant environment according to one embodiment. Method 300 may be performed by processing logic that may comprise hardware (e.g., circuitry, dedicated logic, programmable logic, etc.), software (such as instructions run on a processing device), or a combination thereof. In one embodiment, method 300 may be performed by dynamic shortcuts creation and customization mechanism 110 of FIG. 1.

Method 300 begins at block 305 with receiving of a request for creation of a custom keyboard shortcut from a user at a client computing device. At block 310, create the shortcut by assigning one or more tasks to the requested shortcut and further, associate any identifying description provided by user to the shortcut. At block 315, create a listener and associated it with the shortcut and further, house and hide the listener. At block 320, as provided in the request, link two or more tasks to the requested shortcut or merge two or more shortcuts into the requested shortcuts. As previously discussed, the process of block 320 may be optional.

FIG. 3B illustrates a method for dynamic execution of keyboard shortcuts in an on-demand services environment in a multi-tenant environment according to one embodiment. Method 350 may be performed by processing logic that may comprise hardware (e.g., circuitry, dedicated logic, programmable logic, etc.), software (such as instructions run on a processing device), or a combination thereof. In one embodiment, method 350 may be performed by dynamic shortcuts execution framework 202 of FIG. 2.

Method 350 beings at block 355 with receiving of a request for invoking a shortcut from a user at a client computing device. At block 360, the invoked shortcut may be negotiated to be used across multiple domains. It is contemplated that the process of block 360 may be option in that in some embodiments, if listeners from multiple domains have registered to receive the requested shortcut, the negotiation with multiple domains may be triggered. In other embodiments, a listener from a single domain may be registered and negotiations with other domains may not be necessary. At block 365, the invoked request is evaluated for whether it can be executed as requested. At block 370, a determination is made as to whether the requested is to be wholly rejected. If yes, at block 375, the request is rejected and an error is thrown which is communicated to the user via a user interface at the client computing device. At block 380, the process ends.

Referring back to block 370, if the request is not be wholly rejected, at block 385, another determination is made as to whether the request is to be partially rejected (e.g., it can be executed in the primary domain, but not in any or one of the secondary domains). If yes, at block 390, a notification is issued to the user, via the user interface at the client computing device, that a particular portion of the request cannot be executed. The notification may further include a suggestion or proposal regarding altering the shortcut or invoke a different shortcut or the like. The process continues with block 395 where the request is at least partially executed and then the process ends at block 380. Referring back to block 385, if the invocation request is not to be partially rejected, the request is executed at block 395 and the process ends at block 380.

FIGS. 4A-4I illustrate screenshots of layouts 400A-400I as facilitated by dynamic keyboard shortcuts creation and customization mechanism 110 of FIG. 1 according to one embodiment. FIG. 4A illustrates user interface layout 400A representing a navigation layout which may be displayed to a user at a computing device in response to the user pressing “n” for navigation on the keyboard. As illustrated, this navigation layout 400A a list of contacts, organized under contacts tab 402. FIG. 4B illustrates user interface layout 400B providing account details 406 relating to a particular account 404 in response the user highlighting account 404 and pressing “enter” on the keyboard. In one embodiment, account details 406 may provide contact details 408, address information 410, etc. Continuing with this example and FIG. 4C, if the user press “e” for edit on the keyboard, editable layout 400C may be displayed. For example, as illustrated, the user may choose to wish any of the details (e.g., name, telephone number, etc.) of contact information 408, address information 410, etc.

FIG. 4D illustrates a shortcuts layout 400D listing any number and type of standard shortcuts 414 and custom shortcuts 416. Standard shortcuts 414 may include navigational shortcuts, such as “move left”, “open tab”, “enter”, etc., and editing shortcuts, such as “edit”, “save”, etc. Similarly, custom shortcuts 416 may include any variety of shortcuts (e.g., “GetMyNextCase” for getting the next text, etc.), as requested by the user and created using creation and customization mechanism 110 of FIG. 1. FIG. 4E illustrates a user interface layout 400E for editing custom shortcuts 418. For example, action logic 224 of FIG. 2, may facilitate action column 418 listing various actions (e.g., edit, delete) that the user may take with regard to one or more custom shortcuts 418, such as delete “GetMyNextCase” or edit this shortcut to a different shortcut, such as SaveThisFileAndGetMyNextCase, etc. Further, any number and type of other action options, such as action option 420, may be provided to facilitate other actions. For example, by clicking on action option 420, the user may choose to request and create a new custom shortcut to be added to the list of existing custom shortcuts 416. For example, the user may go the keyboard shortcuts setup page on the Console and, for example, follow Setup->Create->Apps->Your Console->“Customize keyboard shortcuts”->Edit to get to layout 400E.

For example, by clicking on action option 420 of FIG. 4E, custom shortcut creation layout 400D of FIG. 4F may be displayed to provide custom keyboard shortcuts window 422 which may be used by the user to request a new custom shortcut. As illustrated, the user my enter a set of information, such as console action 424, console event name 426, key command (to be used as custom shortcut) 428, and any brief description 430 the user may want to have associated with the new custom shortcut. For example, if the user forgets the purpose of shortcut “SHIFT+X”, the associated description, “logout of salesforce.com”, may serve as a reminder. Similarly, for example, the user may choose the shortcut console event name 426 to be “customShortcut” to avoid and potential conflicts with any of the existing or future events in the Console. Once the set of information has been added, the user may choose one of options 432, such as okay or cancel, to proceed.

As previously discussed, the user (e.g., organizations, such as customers, partners, organizations, etc.) may define custom shortcuts 416. In one embodiment, a global console event may be launched and a console listener may then react to these events using an event receiver defined with, for example, Service Cloud Console Integration Toolkit. Using the Integration Toolkit means custom shortcuts 416 may be capable of invoking various Console Toolkit methods, which further means that custom shortcuts 416 may be customized to perform any of the actions supported by the Toolkit along with, for example, Apex and Visualforce callouts, allowing custom shortcuts 416 to be powerful enough to launch a host of user interface and data operations.

Referring back to options 432, the user may choose “okay” to save the shortcut details and move on to layout 400G of FIG. 4G. Since the user may want the new custom shortcut to be available all the times, a listener may also be available at all times in the Console. Now, since footer components are always on the Console page and do not close, they can be regarded as a good fit for housing such as listener. Additionally, the listener may be kept hidden for there is no need to display any unnecessary information to the user each time the new shortcut is involved.

In one embodiment, to build a listener component, a Visualforce page containing the listener logic may be created and named, for example, cccShortcutsListener. Next, the Console footer component may be used to house this listener and this can be accomplished by, for example, the following path: Setup->Customize->Service Cloud Console->Custom Console Components->New. This may provide layout 400G as illustrated in FIG. 4G. For example, component general settings 434 may be provided to include the component name (e.g., ShortcutsListener) and where the user may check the hide option. Similarly, “Shortcuts” may be entered as the button name under component button settings 436, while cccShortcutsListener may be entered as the Visualforce page name at component window settings 438. Accordingly, the new component for cccShortcutsListener may be created and saved 440. In one embodiment, layout 400G represents a custom console component which may be a Visualforce page that is used for customizing, extending, and/or integrating the Service Cloud Console. Further, custom console components help span customization across all pages and tabs in the Console.

FIG. 4H illustrates layout 400H for adding the custom console component to the Console. As illustrated, the new listener component, ShortcutsListener 442, is added to the Console by entering, for example, the following path: Setup->Create->Apps->the User's Console where the listener component is added. Now, next time, the user enters the newly-created custom shortcut, SHIFT+X, the user is logged out of Salesforce.com.

FIG. 4I illustrates layout 400I representing multiple domains across which custom shortcuts 416 may be used. For simplicity, the illustrated embodiment shows a domain 444 to the left having a work tab listing contact names, the middle domain 446 showing social networking options (e.g., Chatter, Email, etc.) for the user and others (e.g., the user's team members or colleagues, etc.) to use to discuss each file (e.g., its contents, performance of the team, etc.) associated with each of the contact list on the left. To the right, another domain 448 is provided that lists complementary information (e.g., customer promotions, pending orders, etc.) relating to the customers in the left domain 444. In one embodiment, custom shortcuts, such as custom shortcuts 416 of FIG. 4D, may be used across any of the multiple domains 444, 446, 448. Further, it is contemplated, for example, domains 444 and 446 may be part of a single domain, where domain 448 may be independent of domains 444, 446 and provide information generated and put together internally at the organization or by an independent company, etc.

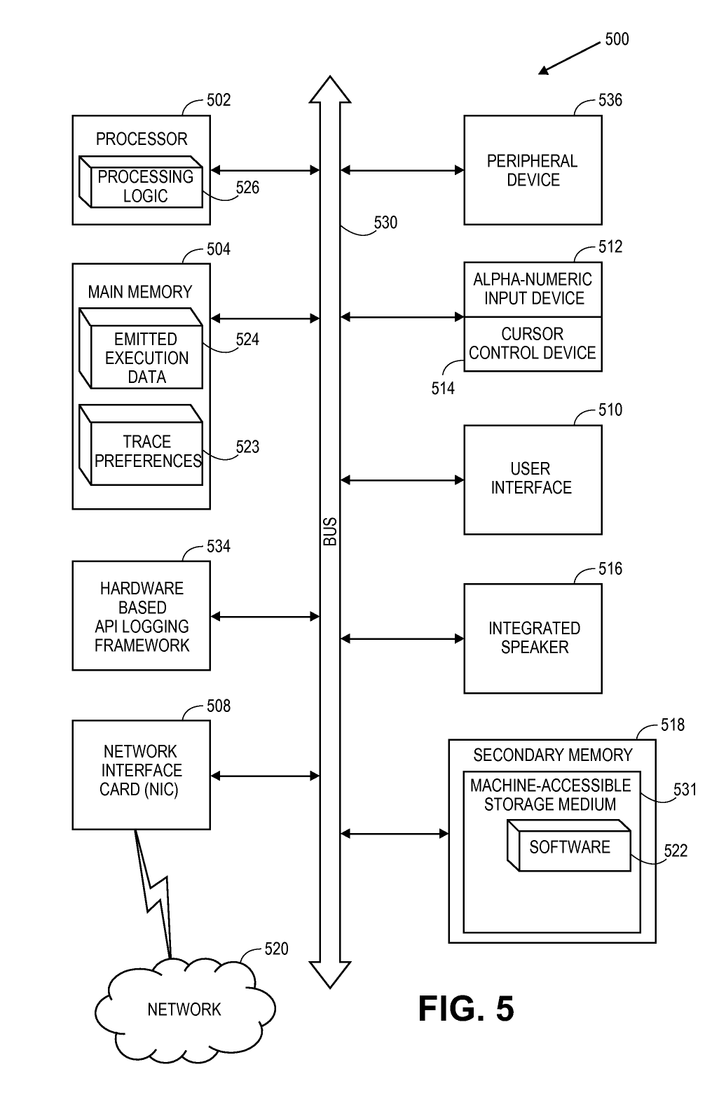

FIG. 5 illustrates a diagrammatic representation of a machine 500 in the exemplary form of a computer system, in accordance with one embodiment, within which a set of instructions, for causing the machine 500 to perform any one or more of the methodologies discussed herein, may be executed. Machine 500 is the same as or similar to computing device 100 and computing device 240 of FIG. 1 and FIG. 2, respectively. In alternative embodiments, the machine may be connected (e.g., networked) to other machines in a network (such as host machine 100 of FIG. 1 connected with client machine 240 over network 230 of FIG. 2), such as a cloud-based network, a Local Area Network (LAN), a Wide Area Network (WAN), a Metropolitan Area Network (MAN), a Personal Area Network (PAN), an intranet, an extranet, or the Internet. The machine may operate in the capacity of a server or a client machine in a client-server network environment, or as a peer machine in a peer-to-peer (or distributed) network environment or as a server or series of servers within an on-demand service environment, including an on-demand environment providing multi-tenant database storage services. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 500 includes a processor 502, a main memory 504 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory 518 (e.g., a persistent storage device including hard disk drives and persistent multi-tenant data base implementations), which communicate with each other via a bus 530. Main memory 504 includes emitted execution data 524 (e.g., data emitted by a logging framework) and one or more trace preferences 523 which operate in conjunction with processing logic 526 and processor 502 to perform the methodologies discussed herein.

Processor 502 represents one or more general-purpose processing devices such as a microprocessor, central processing unit, or the like. More particularly, the processor 502 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 502 may also be one or more special-purpose processing devices such as an application specific integrated circuit (ASIC), a field programmable gate array (FPGA), a digital signal processor (DSP), network processor, or the like. Processor 502 is configured to execute the processing logic 526 for performing the operations and functionality of dynamic keyboard shortcuts creation and customization mechanism 110 as described with reference to FIG. 1 and dynamic shortcuts execution framework 202 as described with reference to FIG. 2 and other figures discussed herein.

The computer system 500 may further include a network interface card 508. The computer system 500 also may include a user interface 510 (such as a video display unit, a liquid crystal display (LCD), or a cathode ray tube (CRT)), an alphanumeric input device 512 (e.g., a keyboard), a cursor control device 514 (e.g., a mouse), and a signal generation device 516 (e.g., an integrated speaker). The computer system 500 may further include peripheral device 536 (e.g., wireless or wired communication devices, memory devices, storage devices, audio processing devices, video processing devices, etc. The computer system 500 may further include a Hardware based API logging framework 534 capable of executing incoming requests for services and emitting execution data responsive to the fulfillment of such incoming requests.

The secondary memory 518 may include a machine-readable storage medium (or more specifically a machine-accessible storage medium) 531 on which is stored one or more sets of instructions (e.g., software 522) embodying any one or more of the methodologies or functions of dynamic keyboard shortcuts creation and customization mechanism 110 as described with reference to FIG. 1 and dynamic shortcuts execution framework 202 as described with reference to FIG. 2 and other figures discussed herein. The software 522 may also reside, completely or at least partially, within the main memory 504 and/or within the processor 502 during execution thereof by the computer system 500, the main memory 504 and the processor 502 also constituting machine-readable storage media. The software 522 may further be transmitted or received over a network 520 via the network interface card 508. The machine-readable storage medium 531 may include transitory or non-transitory machine-readable storage media.

Portions of various embodiments may be provided as a computer program product, which may include a computer-readable medium having stored thereon computer program instructions, which may be used to program a computer (or other electronic devices) to perform a process according to the embodiments. The machine-readable medium may include, but is not limited to, floppy diskettes, optical disks, compact disk read-only memory (CD-ROM), and magneto-optical disks, ROM, RAM, erasable programmable read-only memory (EPROM), electrically EPROM (EEPROM), magnet or optical cards, flash memory, or other type of media/machine-readable medium suitable for storing electronic instructions.

The techniques shown in the figures can be implemented using code and data stored and executed on one or more electronic devices (e.g., an end station, a network element). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. Of course, one or more parts of an embodiment may be implemented using different combinations of software, firmware, and/or hardware.

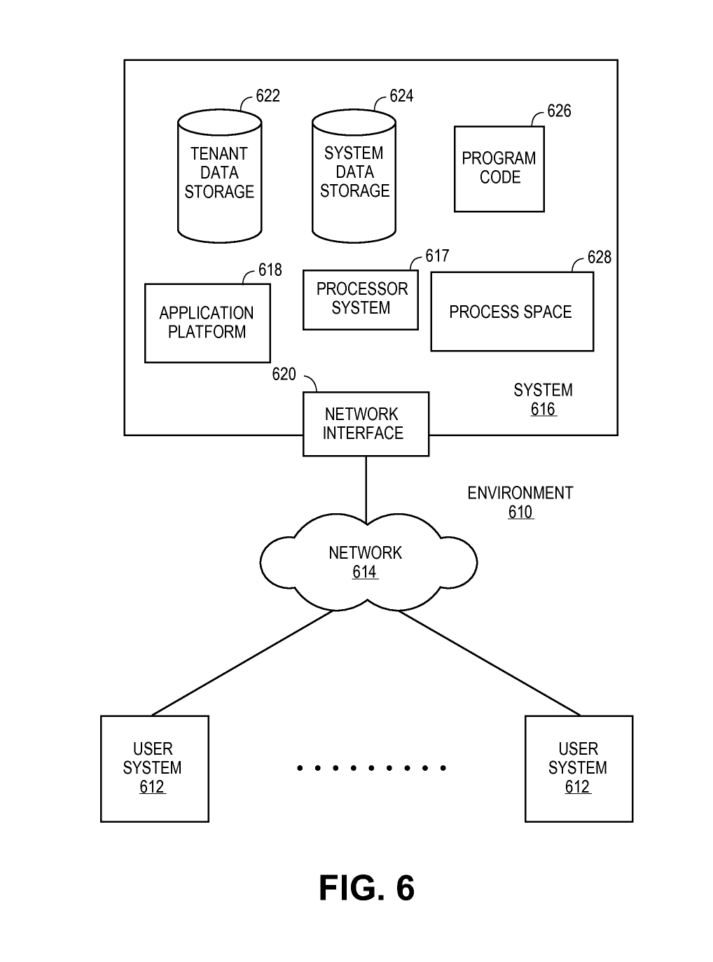

FIG. 6 illustrates a block diagram of an environment 610 wherein an on-demand database service might be used. Environment 610 may include user systems 612, network 614, system 616, processor system 617, application platform 618, network interface 620, tenant data storage 622, system data storage 624, program code 626, and process space 628. In other embodiments, environment 610 may not have all of the components listed and/or may have other elements instead of, or in addition to, those listed above.

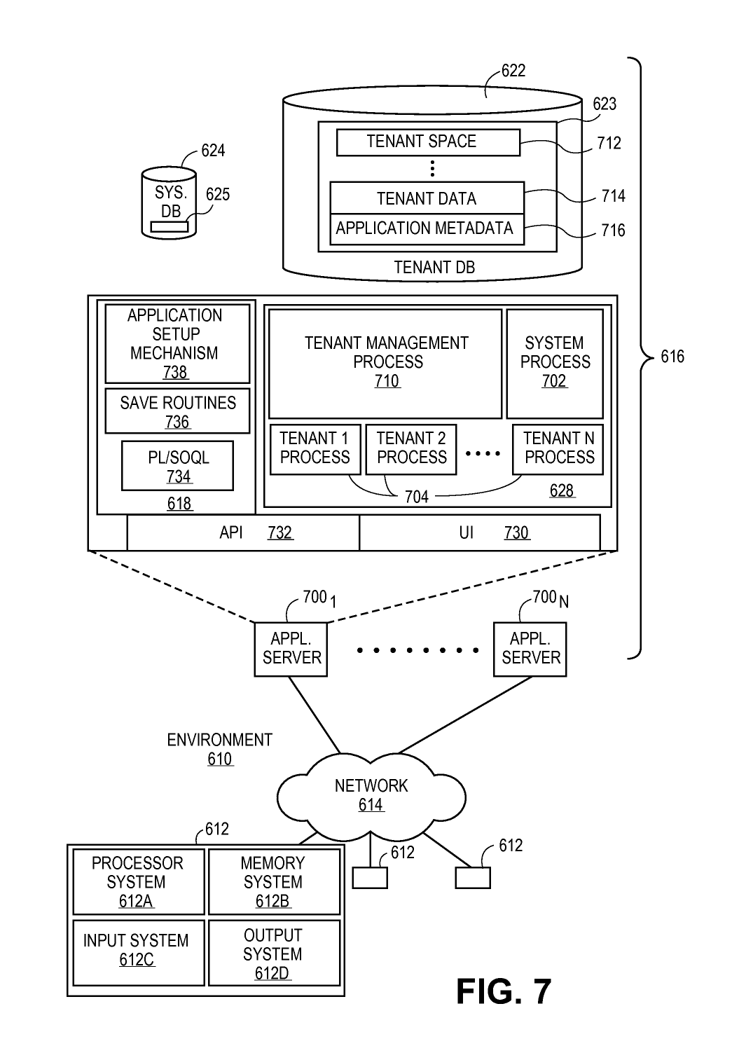

Environment 610 is an environment in which an on-demand database service exists. User system 612 may be any machine or system that is used by a user to access a database user system. For example, any of user systems 612 can be a handheld computing device, a mobile phone, a laptop computer, a work station, and/or a network of computing devices. As illustrated in herein FIG. 6 (and in more detail in FIG. 7) user systems 612 might interact via a network 614 with an on-demand database service, which is system 616.

An on-demand database service, such as system 616, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 616” and “system 616” will be used interchangeably herein. A database image may include one or more database objects. A relational database management system (RDMS) or the equivalent may execute storage and retrieval of information against the database object(s). Application platform 618 may be a framework that allows the applications of system 616 to run, such as the hardware and/or software, e.g., the operating system. In an embodiment, on-demand database service 616 may include an application platform 618 that enables creation, managing and executing one or more applications developed by the provider of the on-demand database service, users accessing the on-demand database service via user systems 612, or third party application developers accessing the on-demand database service via user systems 612.

The users of user systems 612 may differ in their respective capacities, and the capacity of a particular user system 612 might be entirely determined by permissions (permission levels) for the current user. For example, where a salesperson is using a particular user system 612 to interact with system 616, that user system has the capacities allotted to that salesperson. However, while an administrator is using that user system to interact with system 616, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 614 is any network or combination of networks of devices that communicate with one another. For example, network 614 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that one or more implementations might use are not so limited, although TCP/IP is a frequently implemented protocol.

User systems 612 might communicate with system 616 using TCP/IP and, at a higher network level, use other common Internet protocols to communicate, such as HTTP, FTP, AFS, WAP, etc. In an example where HTTP is used, user system 612 might include an HTTP client commonly referred to as a “browser” for sending and receiving HTTP messages to and from an HTTP server at system 616. Such an HTTP server might be implemented as the sole network interface between system 616 and network 614, but other techniques might be used as well or instead. In some implementations, the interface between system 616 and network 614 includes load sharing functionality, such as round-robin HTTP request distributors to balance loads and distribute incoming HTTP requests evenly over a plurality of servers. At least as for the users that are accessing that server, each of the plurality of servers has access to the MTS′ data; however, other alternative configurations may be used instead.

In one embodiment, system 616, shown in FIG. 6, implements a web-based customer relationship management (CRM) system. For example, in one embodiment, system 616 includes application servers configured to implement and execute CRM software applications as well as provide related data, code, forms, webpages and other information to and from user systems 612 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 616 implements applications other than, or in addition to, a CRM application. For example, system 616 may provide tenant access to multiple hosted (standard and custom) applications, including a CRM application. User (or third party developer) applications, which may or may not include CRM, may be supported by the application platform 618, which manages creation, storage of the applications into one or more database objects and executing of the applications in a virtual machine in the process space of the system 616.

One arrangement for elements of system 616 is shown in FIG. 6, including a network interface 620, application platform 618, tenant data storage 622 for tenant data 623, system data storage 624 for system data 625 accessible to system 616 and possibly multiple tenants, program code 626 for implementing various functions of system 616, and a process space 628 for executing MTS system processes and tenant-specific processes, such as running applications as part of an application hosting service. Additional processes that may execute on system 616 include database indexing processes.

Several elements in the system shown in FIG. 6 include conventional, well-known elements that are explained only briefly here. For example, each user system 612 could include a desktop personal computer, workstation, laptop, PDA, cell phone, or any wireless access protocol (WAP) enabled device or any other computing device capable of interfacing directly or indirectly to the Internet or other network connection. User system 612 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 612 to access, process and view information, pages and applications available to it from system 616 over network 614. User system 612 further includes Mobile OS (e.g., iOS® by Apple®, Android®, WebOS® by Palm®, etc.). Each user system 612 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 616 or other systems or servers. For example, the user interface device can be used to access data and applications hosted by system 616, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 612 and all of its components are operator configurable using applications, such as a browser, including computer code run using a central processing unit such as an Intel Core® processor or the like. Similarly, system 616 (and additional instances of an MTS, where more than one is present) and all of their components might be operator configurable using application(s) including computer code to run using a central processing unit such as processor system 617, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 616 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™ JavaScript, ActiveX, any other scripting language, such as VBScript, and many other programming languages as are well known may be used. (Java™ is a trademark of Sun Microsystems, Inc.).

According to one embodiment, each system 616 is configured to provide webpages, forms, applications, data and media content to user (client) systems 612 to support the access by user systems 612 as tenants of system 616. As such, system 616 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 7 also illustrates environment 610. However, in FIG. 7 elements of system 616 and various interconnections in an embodiment are further illustrated. FIG. 7 shows that user system 612 may include processor system 612A, memory system 612B, input system 612C, and output system 612D. FIG. 7 shows network 614 and system 616. FIG. 7 also shows that system 616 may include tenant data storage 622, tenant data 623, system data storage 624, system data 625, User Interface (UI) 730, Application Program Interface (API) 732, PL/SOQL 734, save routines 736, application setup mechanism 738, applications servers 700₁-700_{N}, system process space 702, tenant process spaces 704, tenant management process space 710, tenant storage area 712, user storage 714, and application metadata 716. In other embodiments, environment 610 may not have the same elements as those listed above and/or may have other elements instead of, or in addition to, those listed above.

User system 612, network 614, system 616, tenant data storage 622, and system data storage 624 were discussed above in FIG. 6. Regarding user system 612, processor system 612A may be any combination of one or more processors. Memory system 612B may be any combination of one or more memory devices, short term, and/or long term memory. Input system 612C may be any combination of input devices, such as one or more keyboards, mice, trackballs, scanners, cameras, and/or interfaces to networks. Output system 612D may be any combination of output devices, such as one or more monitors, printers, and/or interfaces to networks. As shown by FIG. 7, system 616 may include a network interface 620 (of FIG. 6) implemented as a set of HTTP application servers 700, an application platform 618, tenant data storage 622, and system data storage 624. Also shown is system process space 702, including individual tenant process spaces 704 and a tenant management process space 710. Each application server 700 may be configured to tenant data storage 622 and the tenant data 623 therein, and system data storage 624 and the system data 625 therein to serve requests of user systems 612. The tenant data 623 might be divided into individual tenant storage areas 712, which can be either a physical arrangement and/or a logical arrangement of data. Within each tenant storage area 712, user storage 714 and application metadata 716 might be similarly allocated for each user. For example, a copy of a user's most recently used (MRU) items might be stored to user storage 714. Similarly, a copy of MRU items for an entire organization that is a tenant might be stored to tenant storage area 712. A UI 730 provides a user interface and an API 732 provides an application programmer interface to system 616 resident processes to users and/or developers at user systems 612. The tenant data and the system data may be stored in various databases, such as one or more Oracle™ databases.

Application platform 618 includes an application setup mechanism 738 that supports application developers' creation and management of applications, which may be saved as metadata into tenant data storage 622 by save routines 736 for execution by subscribers as one or more tenant process spaces 704 managed by tenant management process 710 for example. Invocations to such applications may be coded using PL/SOQL 734 that provides a programming language style interface extension to API 732. A detailed description of some PL/SOQL language embodiments is discussed in commonly owned U.S. Pat. No. 7,730,478 entitled, “Method and System for Allowing Access to Developed Applicants via a Multi-Tenant Database On-Demand Database Service”, issued Jun. 1, 2010 to Craig Weissman, which is incorporated in its entirety herein for all purposes. Invocations to applications may be detected by one or more system processes, which manage retrieving application metadata 716 for the subscriber making the invocation and executing the metadata as an application in a virtual machine.

Each application server 700 may be communicably coupled to database systems, e.g., having access to system data 625 and tenant data 623, via a different network connection. For example, one application server 700₁ might be coupled via the network 614 (e.g., the Internet), another application server 700_{N-1} might be coupled via a direct network link, and another application server 700_{N} might be coupled by yet a different network connection. Transfer Control Protocol and Internet Protocol (TCP/IP) are typical protocols for communicating between application servers 700 and the database system. However, it will be apparent to one skilled in the art that other transport protocols may be used to optimize the system depending on the network interconnect used.

In certain embodiments, each application server 700 is configured to handle requests for any user associated with any organization that is a tenant. Because it is desirable to be able to add and remove application servers from the server pool at any time for any reason, there is preferably no server affinity for a user and/or organization to a specific application server 700. In one embodiment, therefore, an interface system implementing a load balancing function (e.g., an F5 Big-IP load balancer) is communicably coupled between the application servers 700 and the user systems 612 to distribute requests to the application servers 700. In one embodiment, the load balancer uses a least connections algorithm to route user requests to the application servers 700. Other examples of load balancing algorithms, such as round robin and observed response time, also can be used. For example, in certain embodiments, three consecutive requests from the same user could hit three different application servers 700, and three requests from different users could hit the same application server 700. In this manner, system 616 is multi-tenant, wherein system 616 handles storage of, and access to, different objects, data and applications across disparate users and organizations.

As an example of storage, one tenant might be a company that employs a sales force where each salesperson uses system 616 to manage their sales process. Thus, a user might maintain contact data, leads data, customer follow-up data, performance data, goals and progress data, etc., all applicable to that user's personal sales process (e.g., in tenant data storage 622). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 616 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 616 might also maintain system level data usable by multiple tenants or other data. Such system level data might include industry reports, news, postings, and the like that are sharable among tenants.

In certain embodiments, user systems 612 (which may be client systems) communicate with application servers 700 to request and update system-level and tenant-level data from system 616 that may require sending one or more queries to tenant data storage 622 and/or system data storage 624. System 616 (e.g., an application server 700 in system 616) automatically generates one or more SQL statements (e.g., one or more SQL queries) that are designed to access the desired information. System data storage 624 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Any of the above embodiments may be used alone or together with one another in any combination. Embodiments encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements. It is to be understood that the above description is intended to be illustrative, and not restrictive.

What is claimed is:

1. A method comprising:
receiving, at a computing device, a request from a user to invoke a keyboard shortcut across a plurality of web domains at the computing device, wherein the plurality of web domains comprise a primary web domain and one or more secondary web domains;
facilitating interaction between the primary web domain and the one or more secondary web domains, wherein facilitating interaction includes negotiating invocation of the shortcut within the one or more secondary web domains; and
invoking the shortcut across the plurality of web domains.

2. The method of claim 1, wherein invoking comprises facilitating use of the shortcut across the plurality of web domains.

3. The method of claim 1, further comprising wholly rejecting the request and throwing an error at the computing device.

4. The method of claim 3, further comprising partially rejecting the request, wherein partially rejection comprises one or more of invoking the shortcut across the primary web domain or invoking the shortcut across the primary web domain and one or more of the one or more secondary web domains, wherein partially rejecting further comprises issuing a partial rejection notification to the user via the computing device.

5. The method of claim 1, wherein the plurality of web domains comprise a plurality of software applications including a plurality of websites, wherein each website is independent of other websites of the plurality of websites.

6. A method comprising:
receiving, at a server computing device, a request to create a keyboard shortcut to perform one or more tasks, wherein the request is placed at a client computing device;
creating the shortcut to perform the one or more tasks, wherein creating includes customizing the shortcut by associating the one or more tasks to the shortcut representing the shortcut; and
facilitating use of the shortcut over multiple web domains at the client computing device.

7. The method of claim 6, wherein creating further comprises associating a listener component to the shortcut to facilitate continuous availability of the shortcut.

8. The method of claim 6, wherein customizing further comprises merging two or more existing shortcuts into the shortcut.

9. The method of claim 6, wherein the plurality of web domains comprise a plurality of software applications including a plurality of websites, wherein each website is independent of other websites of the plurality of websites.

10. The method of claim 6, wherein the one or more tasks relate to manipulation of data within the plurality of web domains, wherein the one or more tasks comprise one or more data navigation tasks, one or more data editing tasks, and one or more data saving tasks.

11. A system comprising:
a computing device having a memory to store instructions, and a processing device to execute the instructions, the computing device further having a mechanism to perform one or more operations comprising:
receiving a request from a user to invoke a keyboard shortcut across a plurality of web domains at the computing device, wherein the plurality of web domains comprise a primary web domain and one or more secondary web domains;
facilitating interaction between the primary web domain and the one or more secondary web domains, wherein facilitating interaction includes negotiating invocation of the shortcut within the one or more secondary web domains; and
invoking the shortcut across the plurality of web domains.

12. The system of claim 11, wherein invoking comprises facilitating use of the shortcut across the plurality of web domains.

13. The system of claim 11, wherein the one or more operations further comprise wholly rejecting the request and throwing an error at the computing device.

14. The system of claim 13, wherein the one or more operations further comprise partially rejecting the request, wherein partially rejection comprises one or more of invoking the shortcut across the primary web domain or invoking the shortcut across the primary web domain and one or more of the one or more secondary web domains, wherein partially rejecting further comprises issuing a partial rejection notification to the user via the computing device.

15. The system of claim 11, wherein the plurality of web domains comprise a plurality of software applications including a plurality of websites, wherein each website is independent of other websites of the plurality of websites.

16. A machine-readable medium having stored thereon instructions which, when executed by a processor, cause the processor to perform one or more operations comprising:
receiving, at a computing device, a request from a user to invoke a keyboard shortcut across a plurality of web domains at the computing device, wherein the plurality of web domains comprise a primary web domain and one or more secondary web domains;
facilitating interaction between the primary web domain and the one or more secondary web domains, wherein facilitating interaction includes negotiating invocation of the shortcut within the one or more secondary web domains; and
invoking the shortcut across the plurality of web domains.

17. The machine-readable medium of claim 16, wherein invoking comprises facilitating use of the shortcut across the plurality of web domains.

18. The machine-readable medium of claim 16, wherein the one or more operations further comprise wholly rejecting the request and throwing an error at the computing device.

19. The machine-readable medium of claim 18, wherein the one or more operations further comprise partially rejecting the request, wherein partially rejection comprises one or more of invoking the shortcut across the primary web domain or invoking the shortcut across the primary web domain and one or more of the one or more secondary web domains, wherein partially rejecting further comprises issuing a partial rejection notification to the user via the computing device.

20. The machine-readable medium of claim 16, wherein the plurality of web domains comprise a plurality of software applications including a plurality of websites, wherein each website is independent of other websites of the plurality of websites.
